(19) United States
(12) Patent Application Publication
(10) Pub. No.: US 2017/0034189 A1
(43) Pub. Date: Feb. 2, 2017

(54) REMEDIATING RANSOMWARE

(71) Applicant: TREND MICRO INCORPORATED, Tokyoi (JP)

(72) Inventor: Mat Rob Powell, Bentonville, AR (US)

(21) Appl. No.: 14/815,452

(22) Filed: Jul. 31, 2015

(51) Int. Cl. H04L 29/06

(52) U.S. Cl. CPC H04L 63/1416; H04L 63/145; H04L 63/1425

(57) ABSTRACT

Methods and apparatus for ransonnware remediation are disclosed. Network traffic for at least one network user is monitored. A data signature is detected, indicating that one network user has been infected by a ransonnware application. An encryption key is extracted from the detected data signature. The encryption key is stored with an identifier of the network user. The encryption key is used to decrypt one or more files of the network user.

### BACKGROUND

Malicious computer software—sometimes called malware—is software which may be used to disrupt computer operation, gather sensitive information, or gain access to private computer systems. Common forms of malware may include trojans, viruses, worms, adware, and spyware.

### BRIEF DESCRIPTION OF THE DRAWINGS

FIG. 1 illustrates an example of a computing system in which the described examples may be implemented.

FIG. 2 illustrates an example system for detecting and remediating a ransonnware infection.

FIG. 3 illustrates an example method detecting and remediating a ransonnware infection.

FIG. 4 is a block diagram that illustrates a computer system upon which embodiments described herein may be implemented.

### DETAILED DESCRIPTION

In recent years, a new type of malware has become widespread—ransomware. Ransomware is a type of malware that may infect and restrict access to a computer system, demanding a ransom be paid in order for the restriction to be removed. Ransomware is often a type of trojan malware, and may infect computer systems by disguising the malicious application and tricking a user into executing it (e.g., the malicious application may be an attachment to an email, or a user may otherwise be tricked into executing the malicious application). Ransomware may encrypt files on an infected system's hard drive, and demand a ransom payment in order to decrypt the encrypted files. Examples of such ransomware include Cryptolocker, Critlocker, and Zerolocker.

Ransomware has been estimated to have extorted tens of millions of dollars from infected users. For example, ZDNet estimated that Cryptolocker extorted roughly $27 million from infected users over a three month time period in 2013. It would be desirable to remediate the damages inflicted by ransomware infections.

Among other advantages, examples such as described enable the remediation of ransomware infections. Among other benefits, examples as described enable protected computers to remove ransomware and unlock encrypted files after the ransomware has been triggered, without need for the end user or administrator to pay the required ransom.

Examples include a computer or computer system of one or more processors, which operate (or implement a method thereof) to remediate a ransomware infection. One or more examples include monitoring network traffic of at least one network user, and detecting a data signature indicating that one network user has been infected by a ransomware application. Once detected, examples provide for extracting an encryption key from the detected data signature, and storing the encryption key with an identifier of the network user.

In further examples, an apparatus is described, comprising a network traffic analyzer, a ransomware signature repository, and an infection log. The network traffic analyzer monitors and analyzes network traffic of at least one network user using a ransomware signature repository in order to detect a data signature indicating that the at least one network user has been infected by a ransomware application. The network traffic analyzer extracts an encryption key from the detected data signature, and stores the encryption key in the infection log, with an identifier of the network user.

In other variations, examples are implemented using instructions that are stored with a non-transitory computer readable medium that is executable by by one or more processors, to cause the one or more processors to perform an example method as described.

Examples described herein provide that methods, techniques, and actions performed by a computing device are performed programmatically, or as a computer-implemented method. Examples may be implemented as hardware, or a combination of hardware (e.g., a processor(s)) and executable instructions (e.g., stored on a machine-readable storage medium). These instructions can be stored in one or more memory resources of the computing device. A programmatically performed step may or may not be automatic.

Examples described herein can be implemented using engines or components, which may be any combination of hardware and programming to implement the functionalities of the engines or components. In examples described herein, such combinations of hardware and programming may be implemented in a number of different ways. For example, the programming for the components may be processor executable instructions stored on at least one non-transitory machine-readable storage medium and the hardware for the components may include at least one processing resource to execute those instructions. In such examples, the at least one machine-readable storage medium may store instructions that, when executed by the at least one processing resource, implement the engines or components. In examples, a system may include the machine-readable storage medium storing the instructions and the processing resource to execute the instructions, or the machine-readable storage medium may be separate but accessible to the system and the processing resource.

Furthermore, examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

As discussed above, ransomware applications may infect users of network devices by disguising the malicious application and tricking the user into executing it (e.g., the malicious application may be an attachment to an email, or a user may otherwise be tricked into executing the malicious application). Examples recognize that a ransomware application can communicate with a command and control (C2) server associated with the ransomware application, such as by way of sending a beacon to the ransomware C2 server, to indicate whether the infected network device is already infected, or has already made a ransom payment. Examples further recognize that in some cases, the ransomware application will not re-infect the network device if the user has already made a ransom payment. Often, the ransomware application exchanges one or more encryption keys with the ransomware C2 server, and encrypts one or more files on the infected network device.

Security devices, such as firewalls or intrusion prevention systems (IPS), may attempt to prevent the transmission of the initial beacon to the ransomware C2 server. However, security devices may only provide for detection of the infection, and not prevention. For example, a security device may not be in-line, or other network appliances such as sFlow may be used. In such situations, it would be advantageous to provide for remediation of ransomware infection and for the decryption of ransomware-encrypted files without making a ransom payment.

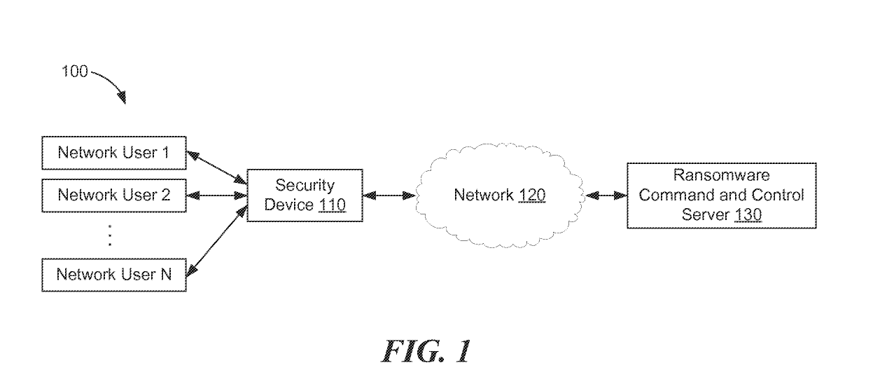

FIG. 1 illustrates an example of a computing system in which the described examples may be implemented. In accordance with some examples, at least one network user may transmit and receive communications with a network 120 (which may be, e.g., the Internet) through a security device 110. In some examples, each of the at least one network users may be a desktop computer, a laptop computer, a mobile phone, a video game console, or another network-connected computing device. In some examples, security device 110 may be a firewall, such as a TippingPoint Next-Generation Firewall (NGFW), or an intrusion prevention system (IPS) such as a TippingPoint Intrusion Prevention System. In other examples, security device 110 may be another network device which may monitor network traffic between the network users and the network 120.

While FIG. 1 depicts network traffic as flowing through the security device 110, other examples provide for the security device 110 to not be inline but rather out-of-band. In such examples, the security device 110 may receive a copy of at least a portion of the network traffic between the network users and the network 120.

With further reference to FIG. 1, network traffic between the at least one network user and the network 120 may be monitored by security device 110. If one network user has become infected with a ransomware application, for example by opening a malicious email attachment, then the network user may communicate with a ransomware command and control (C2) server 130 associated with the ransomware application. The network traffic monitored by security device 110 may include the communications between the network user and the ransomware C2 server 130. The communications between the network user and the ransomware C2 server 130 may have one or more characteristic features, which may allow the security device 110 to detect when monitored communications of the network user include communications with the ransomware C2 server 130. For example, such characteristic features may include a request for encryption status, a hardware id, a username, or another piece of information from the network user. Such characteristic features may also include a payment address, such as a Bitcoin wallet address, as well as cost and timing information. Together, the format and structure of the characteristic features of a network user's communications with the ransomware C2 server 130 may be referred to as a ransomware signature.

In some examples, security device 110 may include at least one ransomware signature, for detecting communications associated with an associated ransomware application. In some examples, security device 110 may include a plurality of ransomware signatures—each of which may be associated with a different ransomware application—which may be stored in a ransomware signature repository. Security device 110 may use the at least one ransomware signature to detect a data signature in the monitored network traffic, indicating that the network user has been infected with a ransomware application. In some examples, security device 110 may store an address of the ransomware C2 server 130, and add the address to a block list.

In accordance with some examples, an infected network user's communications with ransomware C2 server 130 may include an encryption key, for encrypting one or more files on a storage device of the infected network user (e.g., for encrypting one or more files on a hard disk drive of the infected network user). In some examples, the infected network user's communications with ransomware C2 server 130 may include multiple encryption keys. The security device 110 may extract the encryption key (or, encryption keys if multiple keys are present) from the communications with the ransomware C2 server 130. For example, security device 110 may cache communications between the one or more network users and the network 120, and, after detecting a ransomware signature, may extract the encryption key from the cached communications. After extracting the encryption key, the security device 110 may store it, with an identifier of the network user. For example, security device 110 may store the encryption key in an infection log, with an identifier of the infected network user. In some examples, security device 110 may automatically send a notification of infection to the network user in response to storing the encryption key.

In some examples, after extracting and storing the encryption key, security device 110 may initiate a decryption operation, for decrypting the one or more files of the infected network user. In some examples, security device 110 may perform the decryption operation. For example, security device 110 may access the infected network user's files remotely, and perform the decryption operation. In some other examples, the decryption operation may be performed by another suitable computing device. For example, the infected network user's device may include software operable to perform the decryption operation. In some examples, a request for decrypting the one or more files (decryption request) may automatically be generated in response to storing the encryption key. In some other examples, the network user may submit a decryption request. For example, if the network user received a notification of infection, the network user may respond to the notification by submitting a decryption request.

In accordance with some examples, after a security device initiates a decryption operation (e.g., in response to a decryption request), the stored encryption key (or encryption keys if multiple keys are used) may be used for decrypting the encrypted files of the network user. In some examples, the security device 110 (or another suitable computing device for performing the decryption operation) may include a decryption descriptor for each remediable ransomware application. The decryption descriptor provides instructions for decrypting files encrypted files by an associated ransomware application. For example, a decryption descriptor may provide instructions for using the encryption key to decrypt files encrypted by the associated ransomware application. The security device 110 may use the decryption descriptor and the stored encryption key to decrypt the files encrypted by the ransomware application in response to the decryption request.

In accordance with some examples, when the decryption operation has been completed, a notification may be transmitted to the infected network user, indicating that the ransomware infection has been remediated, and the network user's files decrypted. In some examples this notification may be automatically generated and transmitted. In accordance with some examples, after the decryption operation has completed, security device may update the stored encryption key with an indication that the associated ransomware infection has been remediated. In some examples, this update may additionally include a timestamp indicating when the ransomware infection was remediated. This update may also include a log listing the files of the network user which were decrypted during the decryption operation.

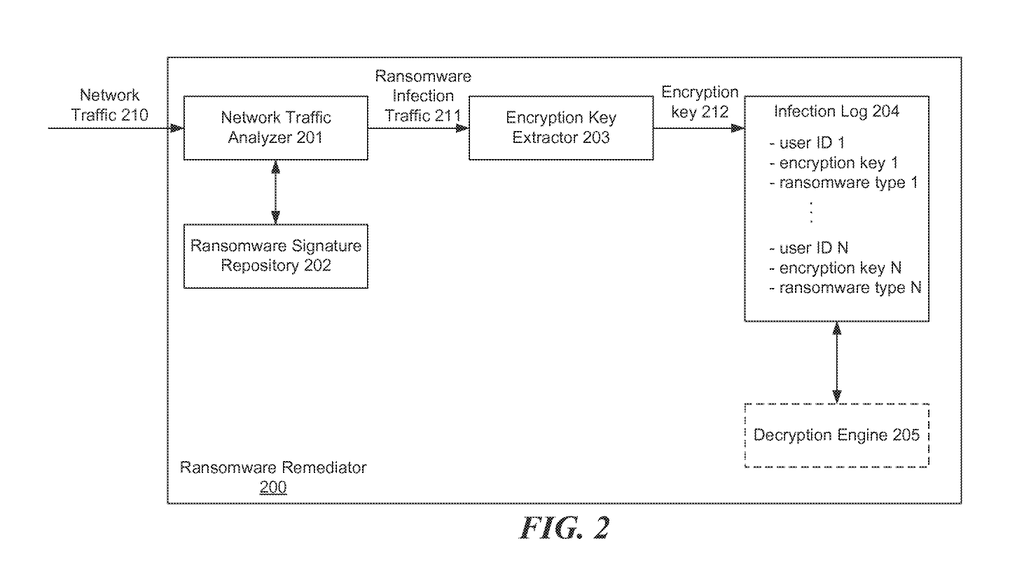

FIG. 2 illustrates an example system for detecting and remediating a ransomware infection. More specifically, with reference to FIG. 2, a ransomware remediator 200 provides an example of security device 110 of FIG. 1. The ransomware remediator 200 can include a network traffic analyzer 201, a ransomware signature repository 202, an encryption key extractor 203, an infection log 204 and a decryption engine 205. The network traffic analyzer 201 can operate to receive network traffic 210 from at least one network user, and to analyze the received network traffic for malicious software. Network traffic analyzer 201 may receive network traffic 210 and may use ransomware signature repository 202 to detect a data signature indicating that a network user has been infected by ransomware application. Ransomware signature repository 202 may contain at least one ransomware signature, where each ransomware signature is associated with a ransomware application. Each ransomware signature may indicate a structure of one or more data transmissions associated with a ransomware application. For example, such data transmission structures may include requests for hardware information, ransom cost information, ransom payment information (such as a bitcoin wallet address), and other transmissions associated with a ransomware application. In some examples, at least one ransomware data signature may include a structure for a transmission to a command and control (C2) server associated with a malware application. In some examples, a transmission to a C2 server may include an encryption key 212 associated with the ransomware infection.

After detecting a data signature indicating that a network user has been infected by a ransomware application, the network traffic analyzer 201 send ransomware infection traffic 211 to encryption key extractor 203. ransomware infection traffic 211 may include the data signature detected by network traffic analyzer 201, which may include an encryption key 212. Encryption key extractor 203 may extract encryption key 212 from the detected data signature. Encryption key extractor 203 may then send encryption key 212 to infection log 204. Infection log 204 may then store the extracted encryption key 212, together with an identifier of the network user. In some examples, the infection log 204 may store additional information about the ransomware infection, such as a timestamp identifying when the infection was detected, a ransomware type identifying the ransomware application detected, an operating system type identifying the operating system of the network user, or other information relating to the detected ransomware infection.

Note that while infection log 204 may contain extracted encryption key 212, as shown in FIG. 2, in other examples, infection log 204 may instead store ransomware infection traffic 211, with an identifier of the network user. In such examples, the encryption key 212 may later be extracted by encryption key extractor 203 (e.g., after the network user requests decryption of one or more files).

In some examples, ransomware remediator 200 may automatically generate a notification to the network user in response to storing the encryption key 212 and network user identifier in infection log 204. In some examples, decryption engine 205 may retrieve the encryption key from infection log 204 using the network user identifier, and use the encryption key to decrypt one or more files of the network user. Note that while the examples have been described as extracting and storing a singular “encryption key,” in some examples the encryption credentials extracted and stored by an example ransomware remediator 200 may include multiple keys.

After the encryption key 212 and user identifier have been stored in infection log 204, decryption engine 205 may initiate a decryption operation to decrypt at least one file encrypted by the ransomware application using the extracted encryption key 212.

Functions described in relation to the examples herein may be implemented by devices via hardware or a combination of hardware and instructions for the hardware. For example, components of FIG. 2 may be implemented via hardware which is instructed to perform functionality associated with the components, utilizing instructions stored in memory.

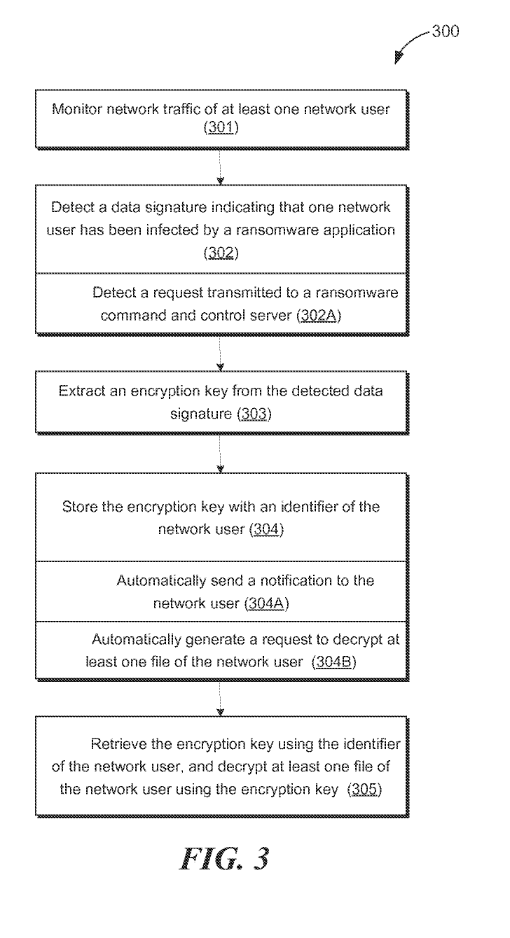

FIG. 3 illustrates an example method detecting and remediating a ransomware infection. The method depicted in FIG. 3 may be performed, e.g., by security device 110 of FIG. 1 or ransomware remediator 200 of FIG.

In accordance with some examples, network traffic of at least one network user can be monitored (301). In some examples this network traffic may be monitored by network traffic analyzer 201 of FIG. 2. A data signature may be detected indicating that one network user has been infected by a ransomware application (302). In some examples, this data signature may be detected by comparing its structure to at least one ransomware signature, which may be stored in ransomware signature repository 202 of ransomware remediator 200 of FIG. 2. In some examples, detecting the data signature may include comparing its structure with each of a plurality of ransomware signatures, where each of the plurality of ransomware signatures indicates a data structure for a detectable ransomware application. In some examples, detecting the data signature may include detecting a request transmitted to a ransomware command and control (C2) server (302A). In some examples, after detecting the request transmitted to the ransomware C2 server, the address of the ransomware C2 server may be determined, and the address added to a block list.

An example ransomware application which may be detected is Cryptolocker. In some examples, detecting a data signature associated with Cryptolocker may include one or more of: detecting an initial request sending a hardware ID, a command for status, a NetBIOS name, and a username; detecting a response from the C2 server indicating a status, a bitcoin wallet address, a cost, a bit coin balance, and a timer; and detecting a response from the C2 server indicating that the network user's files are not encrypted.

In accordance with some examples, after detecting a data signature indicating that one network user has been infected by a ransomware application, an encryption key may be extracted from the detected data signature (303). In some examples this encryption key may include multiple pieces. In some examples, the encryption key may be extracted by encryption key extractor 203, as provided in an example of FIG. 2. In some examples, the encryption key may be extracted from a transmitted request to a ransomware C2 server.

In accordance with some examples, the extracted encryption key may be stored with an identifier of the network user (304). In some examples the encryption key and user identifier may be stored in infection log 204 of FIG. 2. In some examples, a notification may automatically be sent to the network user in response to storing the encryption key and the user identifier (304A). In some other examples, a request may automatically be generated for decrypting at least one file of the network user (30413).

In accordance with some examples, after storing the encryption key with an identifier of the network user, the encryption key may be retrieved using the identifier of the network user, and at least one file of the network user may be decrypted using the encryption key (305). In some examples, this decryption operation may use a decryption descriptor in combination with the encryption key to decrypt the at least one file. In some examples, a notification may be sent to the network user upon completion of the decryption operation. In some other examples, the stored encryption key and user identifier may be updated with information relating to the decryption operation, such a timestamp or a log of decrypted files.

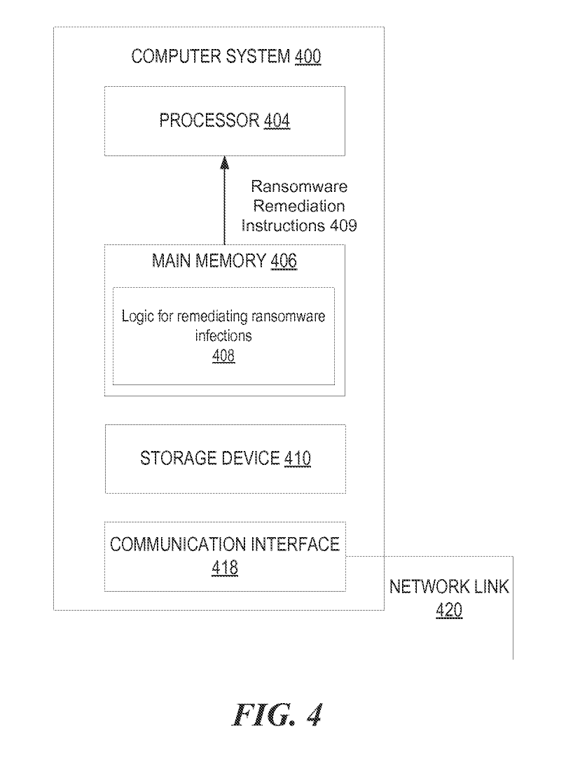

FIG. 4 is a block diagram that illustrates a computer system upon which embodiments described herein may be implemented. For example, in the context of FIG. 1, security device 110 may be implemented using one or more servers such as described by FIG. 4.

In an embodiment, computer system 400 includes processor 404, memory 406 (including non-transitory memory), storage device 410, and communication interface 418. Computer system 400 includes at least one processor 404 for processing information. Computer system 400 also includes the main memory 406, such as a random access memory (RAM) or other dynamic storage device, for storing information and instructions to be executed by processor 404. For example, main memory 406 can store logic for remediating ransomware infections 408, in accordance with some aspects. Main memory 406 also may be used for storing temporary variables or other intermediate information during execution of instructions to be executed by processor 404. Computer system 400 may also include a read only memory (ROM) or other static storage device for storing static information and instructions for processor 404. The storage device 410, such as a magnetic disk or optical disk, is provided for storing information and instructions. The communication interface 418 may enable the computer system 400 to communicate with one or more networks through use of the network link 420 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. For example, processor 404 may execute ransomware remediation instructions 409 to perform ransomware remediation process steps described herein. In alternative embodiments, hard-wired circuitry may be used in place of or in combination with software instructions to implement embodiments described herein. Thus, embodiments described are not limited to any specific combination of hardware circuitry and software.

Although illustrative examples have been described in detail herein with reference to the accompanying drawings, variations to specific examples and details are encompassed by this disclosure. It is intended that the scope of the invention is defined by the following claims and their equivalents. Furthermore, it is contemplated that a particular feature described, either individually or as part of an example, can be combined with other individually described features, or parts of other examples. Thus, absence of describing combinations should not preclude the inventor from claiming rights to such combinations.

What is claimed is:

1. A method for remediating a ransomware infection, the method comprising:
monitoring network traffic of at least one network users;
detecting a data signature indicating that one network user of the at least one network users has been infected by a ransomware application;
extracting an encryption key from the detected data signature; and
storing the encryption key with an identifier of the network user.

2. The method of claim 1, further comprising:
retrieving the encryption key using the identifier of the network user; and
decrypting at least one file of the network user using the encryption key.

3. The method of claim 1, wherein the detected data signature comprises a request transmitted to a command and control server of the ransomware application.

4. The method of claim 2, wherein a request to decrypt at least one file of the network user is automatically generated in response to storing the encryption key.

5. The method of claim 1, further comprising automatically sending a notification to the network user in response to storing the encryption key.

6. The method of claim 1, wherein detecting the data signature comprises detecting one of a plurality of data signatures, each of the plurality of data signatures corresponding to a detectable ransomware application.

7. The method of claim 3, further comprising:
determining an address for the command and control server; and
adding the address for the command and control server to a block list.

8. An apparatus comprising:
a ransomware signature repository;
memory storing an infection log; and
a network traffic analyzer to:
monitor network traffic of at least one network user;
analyze the network traffic using the ransomware signature repository;
detect a data signature indicating that one network user of the at least one network users has been infected by a ransomware application;
extract an encryption key from the detected data signature; and
storing the encryption key in the infection log, with an identifier of the network user.

9. The apparatus of claim 8, wherein the network traffic analyzer is to retrieve the encryption key from the infection log, and decrypt at least one file of the network user using the encryption key.

10. The apparatus of claim 8, wherein the detected data signature comprises a request transmitted to a command and control server of the ransomware application.

11. The apparatus of claim 9, wherein the network traffic analyzer is further to automatically generate a request to decrypt at least one file of the network user in response to storing the encryption key.

12. The apparatus of claim 8, wherein the network traffic analyzer is further to automatically send a notification to the network user in response to storing the encryption key.

13. The apparatus of claim 8, wherein detecting the data signature comprises detecting one of a plurality of data signatures, each of the plurality of data signatures corresponding to a detectable ransomware application.

14. The apparatus of claim 10, wherein the network traffic analyzer is further to:
determine an address for the command and control server; and
add the address for the command and control server to a block list.

15. A non-transitory computer readable medium storing instructions, that when executed by one or more processors, cause the one or more processors to perform steps comprising:
monitoring network traffic of at least one network users;
detecting a data signature indicating that one network user of the at least one network users has been infected by a ransomware application;
extracting an encryption key from the detected data signature; and
storing the encryption key with an identifier of the network user.

16. The non-transitory computer readable medium of claim 15, wherein execution of the instructions further causes the one or more processors to perform steps comprising:
retrieving the encryption key using the identifier of the network user; and
decrypting at least one file of the network user using the encryption key.

17. The non-transitory computer readable medium of claim 16, wherein execution of the instructions further causes the one or more processors to automatically generate a request to decrypt at least one file of the network user in response to storing the encryption key.

18. The non-transitory computer readable medium of claim 15, wherein the data signature comprises a request transmitted to a command and control server of the ransomware application.

19. The non-transitory computer readable medium of claim 15, wherein execution of the instructions further causes the one or more processors to detect the data signature by detecting one of a plurality of data signatures, each of the plurality of data signatures corresponding to a detectable ransomware application.

20. The non-transitory computer readable medium of claim 15, wherein execution of the instructions further causes the one or more processors to automatically generate a notification to the network user in response to storing the encryption key.
